(19) United States
(12) Patent Application Publication
(10) Pub. No.: US 2021/0155145 A1
(43) Pub. Date: May 27, 2021

(54) VEHICLE ACCESSORY MOUNTING SYSTEM AND VEHICLE ACCESSORY MOUNTING METHOD

(71) Applicant: Ford Global Technologies, LLC, Dearborn, MI (US)

(72) Inventors: Jack Marchlewski, Saline, MI (US); Joshua Robert Hemphill, White Lake, MI (US); Robert Reiners, Ypsilanti, MI (US); Dragan B. Stojkovic, Taylor, MI (US)

(21) Appl. No.: 16/695,825

(22) Filed: Nov. 26, 2019

(51) Int. Cl. B60P 7/08; B60R 9/00; B62D 33/023

(52) U.S. Cl. CPC B60P 7/0807; B62D 33/023; B60R 9/00

(57) ABSTRACT

An accessory mounting system includes, among other things, a mounting plate that attaches to a wall of a vehicle cargo area. The mounting plate includes a ledge configured to support at least a portion of a platform assembly. The mounting plate further including an accessory connection interface separate from the ledge.

### TECHNICAL FIELD

This disclosure relates generally to mounting system for a vehicle and, more particularly, to a mounting plate that can simultaneously support a cargo accessory and a portion of a loading platform.

### BACKGROUND

Vehicles can include cargo areas, such as a bed of a pickup. Within a cargo area, a cargo support can be disposed at a position that is elevated relative to a floor of the cargo area. Cargo can be supported on both the cargo support and the floor of the cargo area.

### SUMMARY

An accessory mounting system according to an exemplary aspect of the present disclosure includes, among other things, a mounting plate that attaches to a wall of a vehicle cargo area. The mounting plate includes a ledge configured to support at least a portion of a platform assembly. The mounting plate further including an accessory connection interface separate from the ledge.

In another example of the foregoing system, the portion of the platform assembly is removably supported on the ledge.

In another example of any of the foregoing systems, the mounting plate is a first mounting plate on a first wall of the vehicle cargo area. The system further includes a second mounting plate that attaches to an opposite, second wall of the vehicle cargo area. The portion of the platform assembly is a brace extending from the ledge of the first mounting plate to a ledge of the second mounting plate.

Another example of the foregoing system includes a deck and a brace of the platform assembly. The portion of the platform assembly is the brace, and the deck is supported by the brace such that the deck is vertically elevated relative to a floor of the cargo area.

In another example of the foregoing system, the vehicle cargo area is a pickup bed.

Another example of the foregoing system includes a cargo accessory removably coupled to the mounting plate through the accessory connection interface.

In another example of the foregoing system, the cargo accessory is a tie-down cleat.

In another example of the foregoing system, the cargo accessory includes an engagement portion. The accessory connection interface is an aperture provided by a plurality of edges of the mounting plate. The engagement portion including a hooked portion that fits over at least one of the edges when the cargo accessory is coupled to the mounting plate.

Another example of the foregoing system includes the portion of the platform assembly supported on the ledge. The mounting plate include a spacer that maintains the portion of the platform assembly at a position spaced laterally from the accessory connection interface such that the portion does not interfere with a coupling of a cargo accessory to the mounting plate through the accessory connection interface.

In another example of the foregoing system, the accessory connection interface is disposed on a vertically extending portion of the mounting plate. The ledge extends horizontally from vertically extending portion.

Another example of the foregoing system includes at least one mechanical fastener that secures the vertically extending portion to a sidewall of a pickup truck bed.

Another example of the foregoing system includes the portion of the platform assembly and at least one mechanical fastener that secures the portion to the ledge.

An accessory mounting system according to another exemplary aspect of the present disclosure includes, among other things, a first mounting plate attached to a first sidewall of a pickup bed, a first cargo accessory removably attached to the first mounting plate, a second mounting plate attached to an opposite second sidewall of the pickup bed, and a second cargo accessory removably attached to the second mounting plate. The system additionally includes a brace of a platform assembly extending longitudinally in a cross-vehicle direction. The brace is supported on a ledge of the first mounting plate and a ledge of the second mounting plate. A deck of the platform assembly supported on the brace to provide a cargo loading platform that is vertically elevated relative to a floor of the pickup bed.

In another example of the foregoing system, the first and second cargo accessories are cargo tie-down cleats.

In another example of any of the foregoing systems, the first and second mounting plates and the brace are horizontally forward a wheel well area of the pickup bed. Also, the brace is a forward brace. The system additionally includes a third and a fourth mounting plate respectively attached to the first sidewall and the second sidewall at positions that are horizontally aft the wheel well area of the pickup bed, and an aft brace that is aft the wheel well area of the pickup bed. The aft brace extends longitudinally in a cross-vehicle direction and is supported on a ledge of the third mounting plate and a ledge of the fourth mounting plate. The platform is additionally supported on the aft brace.

A cargo support providing method according to yet another exemplary aspect of the present disclosure includes, among other things, attaching a mounting plate to a wall of a vehicle cargo area. The mounting plate includes a ledge configured to support a portion of a platform assembly. The mounting plate further includes an accessory connection interface separate from the ledge.

In another example of the foregoing method, the portion of the platform assembly is a brace. The method further includes supporting the brace on the ledge and supporting a deck of the platform assembly on the brace. The deck is supported on the brace such that the deck is vertically elevated relative to a floor of the vehicle cargo area.

Another example of any of the foregoing methods includes engaging a cargo accessory with the accessory connection interface to removably couple the cargo accessory with the mounting plate, the engaging occurring while the brace is supported on the ledge.

In another example of any of the foregoing methods, the cargo accessory is a tie-down cleat.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of an exemplary vehicle including an accessory mounting system in a vehicle cargo area according to an exemplary aspect of the present disclosure.

FIG. 2 illustrates a rear view of the vehicle cargo area of FIG. 1 when the accessory mounting system is utilized to support a platform assembly.

FIG. 3 illustrates a perspective view of a mounting plate of the accessory mounting system of FIG. 1.

FIG. 4 illustrates a perspective view of the mounting plate of FIG. 3 when a cargo accessory is removably coupled to the mounting plate.

FIG. 5 illustrates a section taken at line 5-5 in FIG. 4.

FIG. 6 illustrates a perspective view of the mounting plate of FIG. 4 when the cargo accessory is removably coupled to the mounting plate and when a ledge of the mounting plate is supporting a portion of the platform assembly of FIG. 2.

FIG. 7 illustrates the bracket of FIG. 4 when a cargo accessory of FIG. 6 has been decoupled from the mounting plate 54 and the ledge of the mounting plate 54 is supporting the portion of the platform assembly of FIG. 2.

FIG. 8 illustrates a perspective view of a mounting plate according to another exemplary aspect of the present disclosure.

FIGS. 9 and 10 illustrate the accessory mounting system of FIG. 1 when mounting plates of the accessory mounting system are removably coupled to cargo accessories utilized to hold ramps.

### DETAILED DESCRIPTION

This disclosure relates to an accessory mounting system utilized in connection with a vehicle cargo area. The accessory mounting system includes a mounting plate having a ledge. The ledge can support a portion of a platform assembly. The mounting plate includes an accessory connection interface separate from the ledge. Accessories can be removably coupled to the mounting plate through the accessory connection interface while the ledge is directly supporting the portion of the platform assembly.

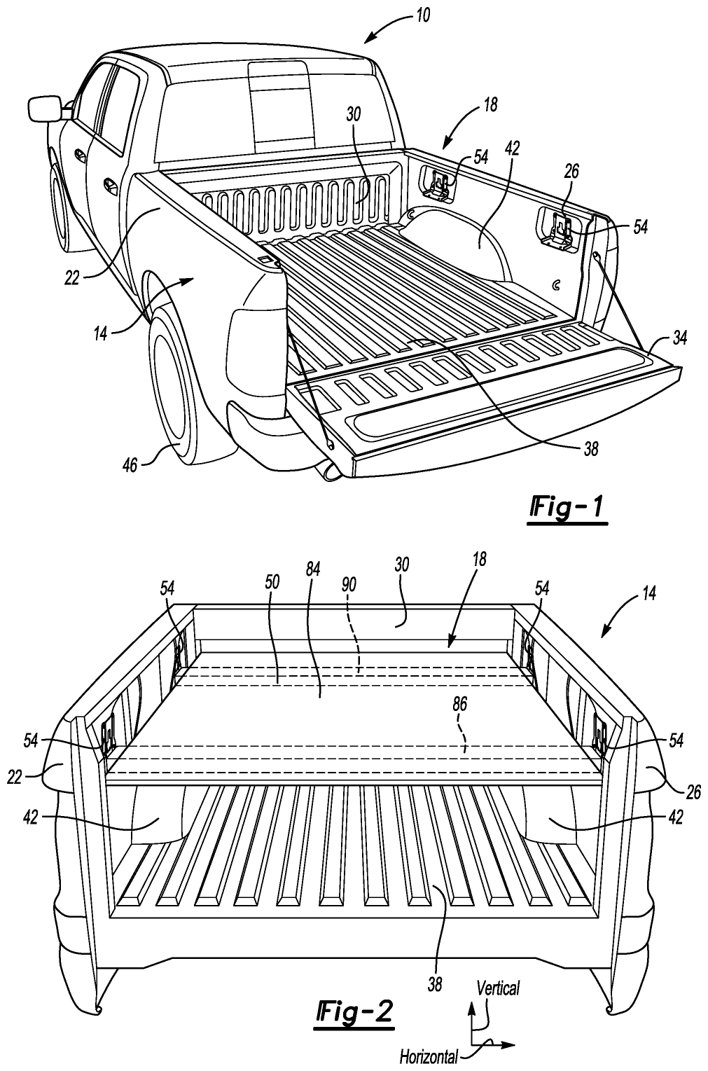

With reference to FIGS. 1, a vehicle 10 is a pickup truck having a bed 14 providing a cargo area 18 according to an exemplary embodiment of the present disclosure. The cargo area 18 is provided, in a cross-vehicle direction, by a driver side vehicle sidewall 22 and a passenger side vehicle sidewall 26. In a longitudinal direction of the vehicle 10, the cargo area 18 is provided by a front wall 30 and a tailgate 34. A floor 38 of the bed 14 establishes a bottom of the cargo area 18. The sidewalls 22 and 26 and the floor 38 provide wheel well areas 42 that accommodate rear wheels 46 of the vehicle 10. Other vehicles could include other types of cargo areas, such as a cargo area within an interior of the vehicle.

FIG. 2 shows a platform assembly 50 mounted within the cargo area 18. When the platform assembly 50 is within the cargo area 18, cargo can be loaded within the cargo area 18 on multiple loading tiers. In particular, in FIG. 2, cargo can be loaded on the floor 38 vertically between the platform assembly 50 and the floor 38. Additional cargo can be loaded atop the platform assembly 50 vertically above the platform assembly 50. Vertical, for purposes of this disclosure, refers to the general orientation of the vehicle 10 during ordinary operation and with reference to ground or horizon.

Two tiers of cargo loading are available when the platform assembly 50 is used. In other examples, other platform assemblies could be included to support cargo loading on more than two tiers.

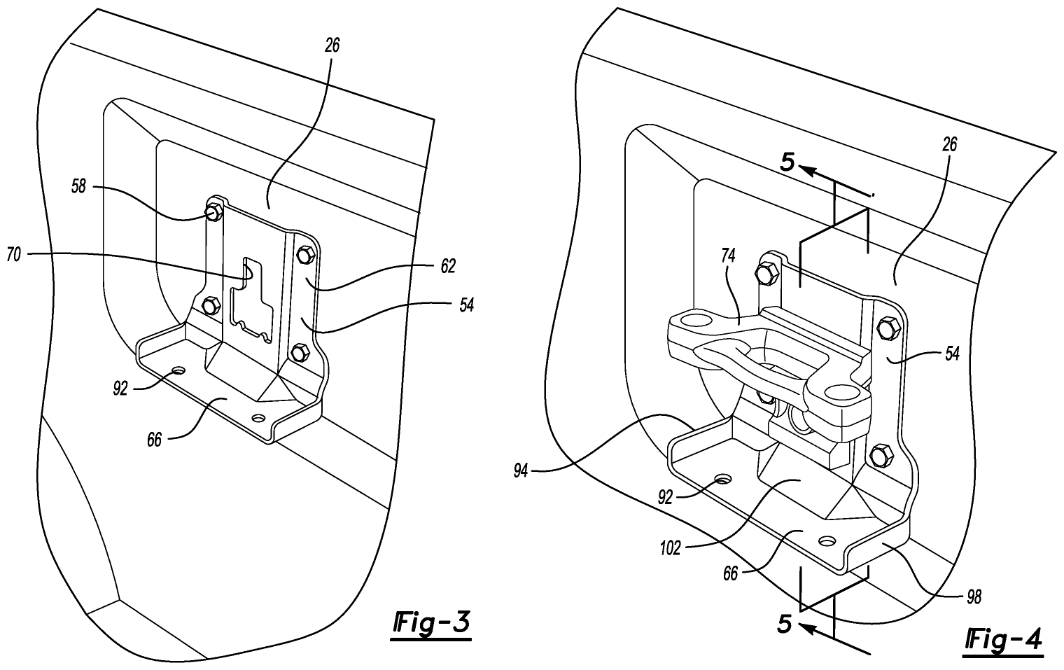

With reference now to FIG. 3 and continued reference to FIGS. 1 and 2, the vehicle 10 includes a plurality of mounting plates 54. In the exemplary embodiment, four mounting plates are secured within the cargo area 18. Two mounting plates 54 are secured to the driver sidewall 22, and two other mounting plates 54 are secured to the passenger sidewall 26. On the driver sidewall 22, one of the mounting plates 54 is disposed forward the wheel well area 42, and the other mounting plate 54 is disposed aft of the wheel well area 42. Similarly, on the passenger sidewall 26, one of the mounting plates 54 is disposed forward the wheel well area 42, and the other mounting plate 54 is disposed aft the wheel well area 42. The mounting plates 54 can be stamped or cast from a metal or metal alloy. The mounting plates 54 could be secured to other walls in other examples, such as the front wall 30 or the tailgate 34.

In the exemplary embodiment, the mounting plates 54 are secured to the respective sidewalls 22 and 26 via a plurality of threaded mechanical fasteners 58. When securing the mounting plates 54, the mechanical fasteners 58 extend through apertures in the mounting plate 54 to threadably engage mounting features within the respective sidewall 22 or 26. In an exemplary embodiment, the mounting plate 54 interfaces with threaded bores within a reinforcement member that is disposed between the inner and outer panels of the respective sidewall 22 or 26. The threaded bores of the reinforcement member can be arranged to interface with mounting plates sold under the BOXLINK® trademark.

Providing threaded bores within a reinforcement member can be particularly useful for aluminum paneled pickup truck beds. Since the threaded bores are within a reinforcement member, it is not necessary to drill and tap aluminum panels of the aluminum pickup truck bed to provide threaded bores.

The mounting plates 54 include an engagement portion 62 and a ledge 66 extending horizontally from a vertically bottom end portion of the engagement portion 62 toward a centerline of the vehicle 10. The engagement portion 62 includes an accessory connection interface 70.

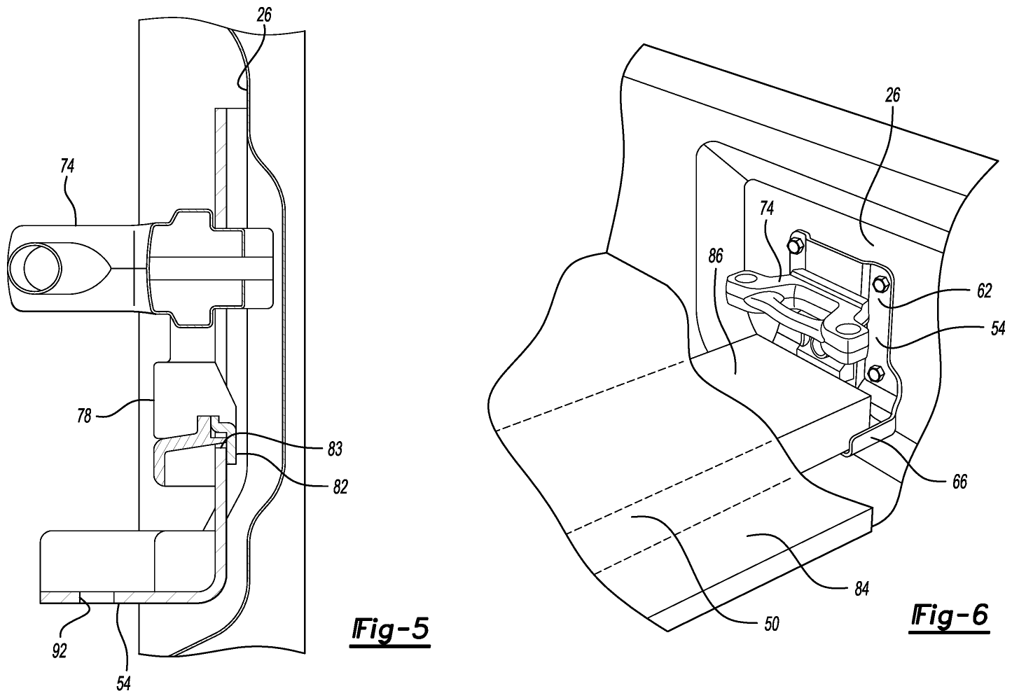

In the exemplary embodiment, the accessory connection interface 70 has a keyhole style design and is bumped out in a cross-car direction relative to areas of the engagement portion 62 that provide openings to receive the mechanical fasteners 58. The accessory connection interface 70 can removably receive a cargo accessory, such as the tie-down cleat 74 as shown in FIGS. 4 and 5.

The tie-down cleat 74 can include a key cylinder 78. To removably couple the tie-down cleat 74 to the mounting plate 54, a user can utilize a key to actuate the key cylinder 78 and turn a flange 82 of the tie-down cleat 74 such that an edge portion 83 of the mounting plate 54 is captured between the flange 82 and other portions of the tie-down cleat 74. When the flange 82 is turned, as shown in FIG. 5, the edge portion 83 is essentially received within a hooked portion of the tie-down cleat 74. This secures the tie-down cleat 74 relative to the mounting plate 54. A rope, strap, etc. can then be secured to the tie-down cleat 74 and used to secure cargo within the cargo area 18.

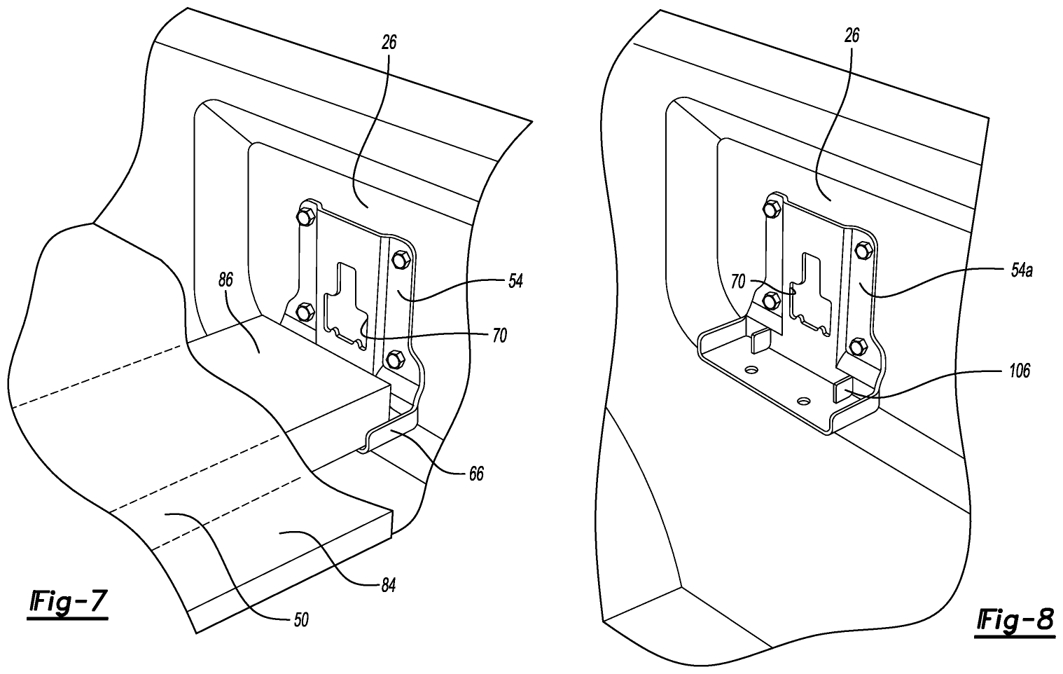

As shown in FIG. 6, the ledge 66 of the mounting plate 54 can support a portion of the platform assembly 50 even when the tie-down cleat 74 is removably coupled to the engagement portion 62 of the mounting plate 54.

In particular, in the exemplary embodiment, the platform assembly 50 includes a deck 84 supported on a rear brace 86 and a front brace 90 (see FIG. 2). As shown in FIG. 6, the brace 86 can fit on the ledge 66 of the mounting plate 54, which is mounted to the sidewall 26 aft the wheel well area 52. The brace 86 can extend longitudinally from the ledge 66 to a position where the brace 86 is supported on another mounting plate 54 mounted to the sidewall 22 aft the wheel well area 42. The brace 90 can extend between ledges of mounting plates 54 mounted forward the wheel well areas 42 on the sidewalls 22 and 26 respectively.

The ledge 66 can include apertures 92. Mechanical fasteners (not shown) can extend through the apertures 92 when the brace 86 is supported on the ledge 66. The mechanical fasteners can engage the brace 86 to secure and stabilize the brace 86 on the ledge 66. An upturned flange 94 at a forward end of the ledge 66 and another upturned flange 98 at an aft end of the ledge 66 can further secure and stabilize the brace 86 on the ledge 66. The flanges 94 and 98 can help to block movement of the brace 86, and thus the platform assembly 50, relative to the mounting plate 54 along a longitudinal axis of the vehicle 10.

Referring to FIG. 7, even while the brace 86 is of the platform assembly 50 is supported by the ledge 66, the tie-down cleat 74 can be decoupled from the accessory connection interface 70 of the mounting plate 54. This provides great flexibility to a user as the user is, among other things, able to couple and decouple the tie-down cleat 74 and other cargo accessories to the mounting plate 54 even while the mounting plate 54 is supporting a portion of the platform assembly 50.

To ensure that the platform assembly maintains clearance in a cross-vehicle direction relative to the accessory connection interface 70, the mounting plate 54 includes a raised area 102, which acts as a spacer preventing an end of the brace 86 from moving outward too close to the accessory connection interface 70 where the brace 86 could potentially interfere with the removable coupling and decoupling of the tie-down cleat 74.

With reference now to FIG. 8, a mounting plate 54A, according to another exemplary aspect of the present disclosure, is not formed with a raised area to act as a spacer, instead, the mounting plate 54A is formed with two flanges 106 that act as a spacer and limit outward movement of the brace 86 to a position where the brace 86 could interfere with the accessory connection interface 70 of the mounting plate 54A.

The cargo accessory is disclosed as a tie-down cleat in FIGS. 4-6. Other types of cargo accessories can be utilized in connection with the mounting plate 54 and the accessory connection interface 70 of the mounting plate. Other cargo accessories can include, for example, other structures and holding mechanisms such as hooks, clamps, etc.

Some cargo accessories are larger than the tie-down cleat 74 shown in FIGS. 4-6 and may extend to a position that would prevent the ledge 66 from simultaneously supporting a portion of a platform assembly.

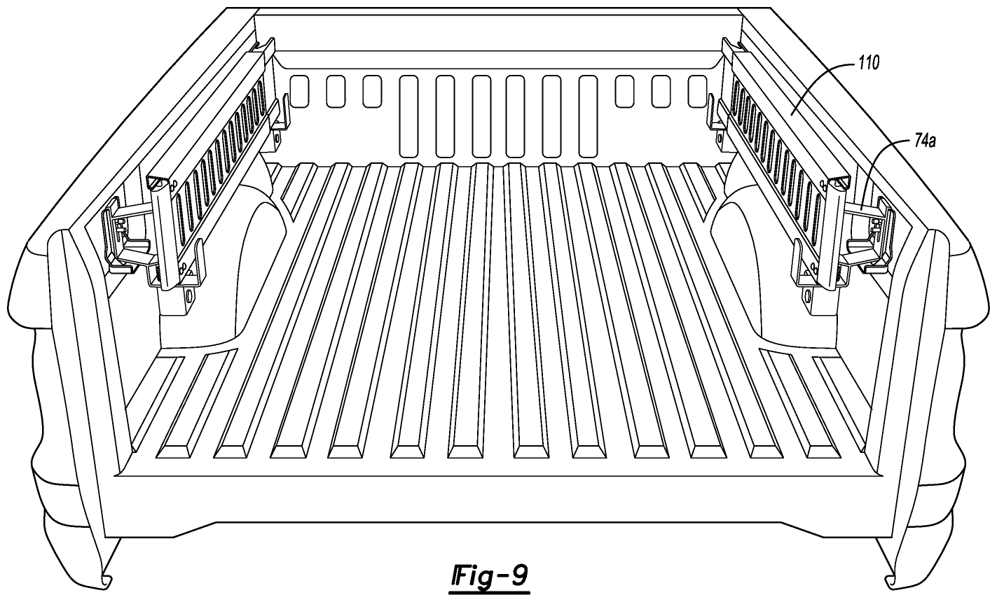

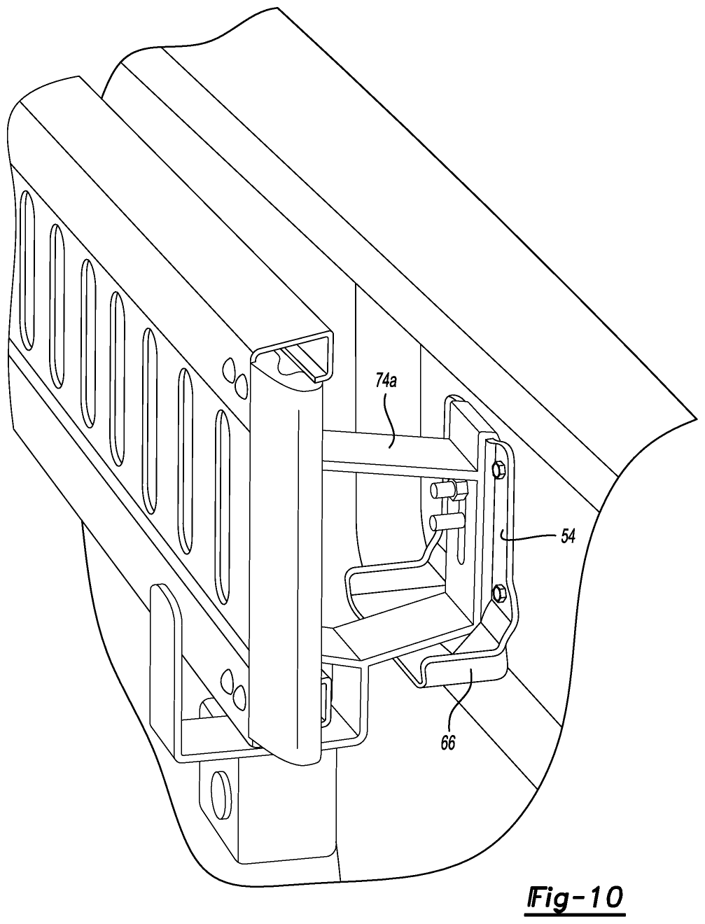

FIGS. 9 and 10 show an example of the cargo accessory 74A, which extends into the area of the ledge 66 of the mounting plate 54. The cargo accessory 74A is a ramp supporting bracket utilized to support and store ramps 110. The ramps 110 can be removed from the cargo accessories 74A and used to load cargo in the cargo area.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. An accessory mounting system, comprising:
a mounting plate that attaches to a wall of a vehicle cargo area, the mounting plate including a ledge configured to support at least a portion of a platform assembly, the mounting plate further including an accessory connection interface separate from the ledge, wherein the accessory connection interface is configured to couple the mounting plate to a cargo accessory when the ledge is supporting the portion of the platform assembly.

2. The accessory mounting system of claim 1, further comprising the portion of the platform assembly is removably supported on the ledge.

3. The accessory mounting system of claim 2, wherein the mounting plate is a first mounting plate on a first wall of the vehicle cargo area, and further comprising a second mounting plate that attaches to an opposite, second wall of the vehicle cargo area, wherein the portion of the platform assembly is a brace extending from the ledge of the first mounting plate to a ledge of the second mounting plate.

4. The accessory mounting system of claim 2, further comprising a deck and a brace of the platform assembly, wherein the portion of the platform assembly is the brace, and the deck is supported by the brace such that the deck is vertically elevated relative to a floor of the cargo area.

5. (canceled)

6. The accessory mounting system of claim 1, further comprising the a cargo accessory removably coupled to the mounting plate through the accessory connection interface.

7. The accessory mounting system of claim 6, wherein the cargo accessory is a tie-down cleat.

8. The accessory mounting system of claim 6, wherein the cargo accessory includes an engagement portion, wherein the accessory connection interface is an aperture provided by a plurality of edges of the mounting plate, the engagement portion including a hooked portion that fits over at least one of the edges when the cargo accessory is coupled to the mounting plate.

9. The accessory mounting system of claim 1, further comprising the portion of the platform assembly supported on the ledge, the mounting plate include a spacer that maintains the portion of the platform assembly at a position spaced laterally from the accessory connection interface such that the portion does not interfere with a coupling of a cargo accessory to the mounting plate through the accessory connection interface.

10. The accessory mounting system of claim 1, wherein the accessory connection interface is disposed on a vertically extending portion of the mounting plate, the ledge extending horizontally from vertically extending portion.

11. (canceled)

12. (canceled)

13. An accessory mounting system, comprising:
a first mounting plate attached to a first sidewall of a pickup bed;
a first cargo accessory removably attached to the first mounting plate;
a second mounting plate attached to an opposite, second sidewall of the pickup bed;
a second cargo accessory removably attached to the second mounting plate;
a brace of a platform assembly extending longitudinally in a cross-vehicle direction, the brace supported on a ledge of the first mounting plate and a ledge of the second mounting plate; and
a deck of the platform assembly supported on the brace to provide a cargo loading platform that is vertically elevated relative to a floor of the pickup bed.

14. (canceled)

15. The accessory mounting system of claim 13, wherein the first and second mounting plates and the brace are horizontally forward a wheel well area of the pickup bed, wherein the brace is a forward brace, and further comprising a third and a fourth mounting plate respectively attached to the first sidewall and the second sidewall at positions that are horizontally aft the wheel well area of the pickup bed, and still further comprising an aft brace that is aft the wheel well area of the pickup bed, the aft brace extending longitudinally in a cross-vehicle direction and supported on a ledge of the third mounting plate and a ledge of the fourth mounting plate, wherein the platform is additionally supported on the aft brace.

16. A cargo support providing method, comprising:
attaching a mounting plate to a wall of a vehicle cargo area, the mounting plate including a ledge configured to support a portion of a platform assembly, the mounting plate further including an accessory connection interface separate from the ledge, the accessory connection interface configured to couple the mounting plate to a cargo accessory when the ledge is supporting the portion of the platform assembly.

17. The cargo support providing method of claim 16, wherein the portion of the platform assembly is a brace, and further comprising supporting the brace on the ledge and supporting a deck of the platform assembly on the brace, the deck supported on the brace such that the deck is vertically elevated relative to a floor of the vehicle cargo area.

18. The cargo support providing method of claim 17, further comprising engaging the cargo accessory with the accessory connection interface to removably couple the cargo accessory with the mounting plate, the engaging occurring while the brace is supported on the ledge.

19. The cargo support providing method of claim 18, wherein the cargo accessory is a tie-down cleat.

20. The accessory mounting system of claim 1, wherein the mounting plate is a continuous and monolithic structure that includes both the accessory connection interface and the ledge.

21. The accessory mounting system of claim 1, wherein the mounting plate provides the the ledge when the accessory connection interface is decoupled from any cargo accessory

22. The accessory mounting system of claim 13, wherein the first mounting plate is configured such that ledge of the first mounting plate can support the brace when the first cargo accessory is attached to the first mounting plate through an accessory connection interface of the first mounting plate.

23. The cargo support providing method of claim 16, wherein attaching the mounting plate to the wall of the vehicle cargo area attaches the ledge to the vehicle cargo area.
